(19) United States
(12) Patent Application Publication
(10) Pub. No.: US 2009/0017244 A1
(43) Pub. Date: Jan. 15, 2009

(54) NYLON TUBING CONSTRUCTIONS

(76) Inventors: Nicola Martino, North Canton, OH (US); Jimmy L. Hensley, Ravenna, OH (US)

Correspondence Address: JOHN MOLNAR JR., PARKER-HANNIFIN CORPORATION, 6035 PARKLAND BOULEVARD, CLEVELAND, OH, 44124-4141, US

(21) Appl. No.: 12/128,212

(22) Filed: May 28, 2008

Related U.S. Application Data
(60) Provisional application No. 60/948,805, filed on Jul. 10, 2007.

(51) Int. Cl. B29D 23/00; B32B 27/34

(52) U.S. Cl. 428/35.7; 264/171.28

(57) ABSTRACT

Tubular polymeric member for articles such as tubing and hoses. The member is formed of composition of a nylon alloy.

### CROSS-REFERENCE TO RELATED CASES

The present application claims the benefit of the filing date of U.S. Provisional Application Ser. No. 60/948,805, filed Jul. 10, 2007, the disclosure of which is expressly incorporated herein by reference.

### BACKGROUND OF THE INVENTION

The present invention relates broadly to tubular nylon members and to articles such as single or multi-layer tubing, which may be straight or coiled, constructed thereof, and more particularly to such members and to such articles for use as airbrake tubing.

Tractor/trailer rigs and other heavy-duty vehicles are conventionally are equipped with pneumatically-operated emergency brakes in addition to usual service airbrakes. In basic operation, and as is further described in U.S. Pat. No. 5,232,645 and U.K. Pat. Appln. GB 2,239,503, pressurized air is supplied from the truck unit to the trailer unit, which may be articulated, for the actuation of the emergency and service brake systems of the trailer. Within the emergency brake system, the braking mechanism normally is released under the condition of a constant air pressure supply. The service brake system, however, is manually actuated with pressurized air being supplied to the breaking mechanism upon the application of the brake pedals by the operator.

Pressurized air from the truck to the trailer unit, or between trailer units in tandem rigs, may be supplied via flexible tubing or hose, with separate, dedicated lines being provided for the independent operation of the emergency and service brake systems. Performance requirements for airbrake tubing generally are subject to various governmental or industry regulations promulgated to ensure the safe operation of the vehicle. In this regard, airbrake tubing conventionally is constructed as having tubular core which optionally may be surrounded, in certain tubing types, by one or more layers of a braided or other wound reinforcement. The core tube may be a thermoplastic material such as a polyamide, polyolefin, polyvinyl chloride, or polyurethane, or a synthetic rubber material such as Buna N or neoprene, with the optional reinforcement preferably being a nylon, polyester, or aramid filament or yarn. For increased abrasion resistance, the core tube and, as the case may be, reinforcement typically are covered with an outer jacket which may be formed of the same or different material as the core tube, but preferably is formed of more abrasion-resistance polymeric material which may be a polyamide, polyolefin, polyvinyl chloride, or polyurethane. Representative airbrake and other tubing constructions, and coils and bundles formed of such tubing, are described in U.S. Pat. Nos. 6,776,195; 6,670,004; 6,576,312; 6,354,331; 6,098,666; 6,071,579; 6,066,377; 5,392,541; 5,232,645; 4,653,541; 4,009,734; 3,977,440; and RE38,087; U.S. Ser. No. 11/331,964, filed Jan. 13, 2006, titled “Tubular Nylon Alloy Members for Tubing and Hose Constructions,” U.S. Pat. Appln. Publs. 2004/0134555; 2004/005811; and 2003/0145896, GB 2367108, WO 99/41537, and U.K. Pat. Appln. 2,239,503. Commercial airbrake tubing and coils are manufactured and sold by the Parflex Division of Parker-Hannifin Corp., Ravenna, Ohio.

Other tubing constructions, such as multi-layer constructions used for fuel line applications, incorporate a bonding or tie layer between an inner fluoropolymer layer or liner and a second layer of a stronger, tougher, and, typically, less-expensive material, such as a nylon, polyamide, or polyurethane, which is used as a reinforcement or cover for the liner. The tie layer, which may be formed as a co- or tri-extrusion with the liner and second layers, is formulated to be compatible chemically with both the fluoropolymer material of the liner and the material of the second layer such that a thermal fusion bond may be achieved between the liner and tie layer and the tie layer and second layer to thereby consolidate the tubing into an integral structure. The use of such tie layers dictates the selection of specific materials for the liner and second layer so as to be compatible with the material of the tie layer, or vice versa, and is believed limited to the use of melt processible fluoropolymers such as polyvinylidene fluoride (PVDF) or ethylene tetraflurorethylene (ETFE).

Multi-layer tubing constructions in general are shown in commonly-assigned U.S. Pat. No. 6,776,195 and U.S. Pat. Appln. Publ. Nos. 2006/0280889 and 2007/0087150. Other constructions are shown in U.S. Pat. Nos. 6,670,004; 6,066,377; 6,041,826; 6,039,085; 6,012,496; 5,996,642; 5,937,911; 5,891,373; 5,884,672; 5,884,671; 5,865,218; 5,743,304; 5,716,684; 5,678,611; 5,570,711; 5,566,720; 5,524,673; 5,507,320; 5,500,263; 5,480,271; 5,469,892; 5,460,771; 5,419,374, 5,383,087; 5,284,184; 5,219,003; 5,167,259; 5,167,259; 5,112,692; 5,112,692; 5,093,166; 5,076,329; 5,076,329; 5,038,833; 5,038,833; 4,706,713; 4,627,844; and 3,561,493, in German Pat. Publ. Nos. DE 4001126; 3942354; and 3921723; and 3821723, in Japanese Pat. Publ. Nos. JP 61171982; 422-4939; and 140585, in Europe Pat. Publ. Nos. EP 1002980, 992518, and 551094, in International (PCT) Publ. Nos. WO 99/41538; 99/41073; 97/44186; and 93/21466, and in U.K. Pat. Publ. No. GB 2204376.

It is believed that alternative single and multi-layer tubular polymeric members would be useful for airbrake tubing applications, and in a variety of other fluid transfer and motion control applications. In this regard, in severe or even normal service environments, such as in mobile or industrial pneumatic or hydraulic applications, hoses and tubing of the type herein involved may be exposed to a variety of environmental factors and mechanical stresses that cannot always be predicted. It is anticipated, therefore, that tubing and hose constructions which offer comparable performance, but which are more economical would be well-received by numerous industries.

### BROAD STATEMENT OF THE INVENTION

The present invention is directed to tubular polymeric members, which may formed by extrusion, co-extrusion, or molding, and articles such as mono- or multi-layer tubing and hoses, which may be straight or coiled, constructed thereof. More particularly, the invention is directed to such members which are formed of an alloy or alloy-like blend of a more chemically-resistant thermoplastic polymeric material, namely a higher polyamide such as Nylon 11 or 12, and a more economical thermoplastic polymeric material, namely a lower polyamide such as a Nylon 4 or 6. These materials may be admixed, such as in an on-line process, to form a homogenous blend.

The tubing members formed of the alloy material of the invention may be particularly adapted for use as single or multi-layer tubing for vehicular airbrake systems, and/or as a core tube or other element in a reinforced tubing and hose constructions, as well as in other applications requiring chemical resistance and/or compliance with industry or governmental standards. Typically in such constructions, the more chemically or environmentally-resistant layers such as the tubing member of the invention are provided as an innermost and/or outermost layer of the structure. In reinforced constructions, such member may be used as a core tube over which one or more layers of a fibrous reinforcement layer are braided or wound to provide resistance to internal or external pressures. Alternatively, such member may be used as an outer layer over the reinforcement layers.

Heretofore in the North American heavy duty truck market constructions for reinforced air brake tubing typically have utilized either two relatively expensive polyamide 11 or 12 layers bonded together through the interstices of an open, spiral wound polyester or nylon fiber reinforcement or a less expensive modified Nylon 6 or Nylon 6/6 layer interposed between two thinner layers of Nylon 11 or 12. In the latter construction, the Nylon 6 or 6/6 layer may be bonded to the Nylon 11 or 12 layers by an intermediate layer of Nylon 6/12 or an anhydride-modified polyolefin tie layer. Although the Nylon 6 or 6/12 layer can be impact modified and plasticized to make it more useful as an air brake tubing material, it nonetheless is highly susceptible to stress cracking when contacted with zinc chloride and loses physical properties when saturated with water, thus the need to protect it by laminating it between layers of Nylon 11 or 12. However, should the relatively thin Nylon 11 or 12 layers be abraded, the inner Nylon 6 or 6/6 layer may be exposed whereupon it is susceptible to stress cracking by contact with zinc chloride, such as may be found in road salt is used to melt ice and snow or near the marine environments. Moreover, when cut the ends of such tubing has exposed Nylon 6 or 6/6 and also may be are in constant contact with fittings having a zinc coating or other zinc content which can form zinc chloride when coming into contact with road salt.

The tubing construction of the present invention therefore contemplates an improved yet still economical mono- or multi-layer air brake tubing construction which utilizes a more zinc chloride resistant Nylon 6/12 layer which may be joined to an outer protective layer of Nylon 11 or 12. As Nylon 6/12 is more zinc chloride resistant than Nylon 6 or 6/6 and its physical properties are affected less when saturated with water, an improved tubing construction can result.

Nylon 6/12 is commercially available as either as a reacted co-polymer or as a compounded alloy of Nylon 6 and Nylon 12. If purchased as a co-polymer or alloy, however, Nylon 6/12 materials tend to be nearly as expensive or even more expensive than available grades of Nylon 11 and Nylon 12 suitable for air brake tubing, and particularly if the Nylon 6/12 is plasticized and impact modified as would be required for its use as a structural component in an airbrake tubing construction. Therefore, a further aspect of the present invention is the use of a Nylon 6/12 alloy that is made by blending Nylon 6 and Nylon 12, such as with a compatibilzer and, if specified, an impact modifier, directly on-line in an extrusion forming process. Such processing allows the airbrake tubing manufacturer to use low cost, commercially available Nylon 6 (or Nylon 4 as the case may be) grades to form economical Nylon 6/12 alloys by blending the Nylon 6 grades with commercially available Nylon 12 (or Nylon 11 as the case may be) grades. Such processing, moreover, saves the tubing manufacturer from having to purchase a Nylon 6/12 co-polymer or alloy from an outside compounder or resin supplier.

The on-line blending further affords the tubing manufacturer the flexibility to tailor the properties of the finished alloy finished by choosing from a wide range of commercially available resins and additives such plasticizers and heat and light stabilizers. Such on-line alloys also may include not only blends of Nylon 12 (or 11) with Nylon 6 (or 4), but also blends of Nylon 12 with a Nylon 6 or 4 co-polymer (the term “co-polymer” being used herein in a general sense to include ter-polymers and higher polymers) such as Nylon 6/6, Nylon 6/66/12, Nylon 6/6/9, Nylon 6/12, Nylon 66/12, Nylon 4/10, Nylon 4/12, and the like. When the on-line blended alloy is used as the inner layer(s) of an air brake tubing construction having an outer layer of Nylon 12, the resulting tubing construction is lower in material cost than an all-Nylon 11 or Nylon 12 tube, but is less susceptible to the detrimental effects of zinc chloride and water saturation than a construction with discreet Nylon 6 and/or Nylon 6/6 layers.

The present invention, accordingly, comprises the materials, process, and the articles constructed which are exemplified in the detailed disclosure to follow. Advantages of the present invention include a tubular nylon alloy member which may be used alone as tubing or as core tube for hose, and which provides improved physical properties and chemical resistance as compare to Nylon 6 or 6/6 materials. Additional advantages include a tubing construction which is economical to manufacture, and which meets applicable DOT and SAE standards for airbrake tubing and coils such as SAE Standard J844, “Nonmetallic Air Brake System Tubing,” (June 1998), SAE Standard J2484, “Push-To-Connect Tube Fittings for Use in the Piping of Vehicular Air Brake,” (May 2000), and SAE Standard J1131, “Performance Requirements for SAE J844 Nonmetallic Tubing and Fitting Assemblies Used in Automotive Air Brake Systems,” (August 1998), and NHSA/DOT FMVSS 106 (49 CFR § 571.106). These and other advantages should be apparent to those skilled in the art based upon the disclosure contained herein.

### BRIEF DESCRIPTION OF THE DRAWINGS

For a fuller understanding of the nature and objects of the invention, reference should be had to the following detailed description taken in connection with the accompanying drawings wherein:

FIG. 1 is a perspective cut-away view of a representative multi-layer tubing construction according to the present invention;

FIG. 2 is a radial cross-sectional view of the tubing construction of FIG. 1 taken through line 2-2 of FIG. 1;

FIG. 3 is a perspective cut-away view of another representative multi-layer tubing construction according to the present invention;

FIG. 4 is a radial cross-sectional view of the tubing construction of FIG. 3 taken through line 4-4 of FIG. 3;

FIG. 5 is a perspective cut-away view of another representative multi-layer tubing construction according to the present invention; and

FIG. 6 is a radial cross-sectional view of the tubing construction of FIG. 5 taken through line 6-6 of FIG. 5.

The drawings will be described further in connection with the following Detailed Description of the Invention.

### DETAILED DESCRIPTION OF THE INVENTION

Certain terminology may be employed in the description to follow for convenience rather than for any limiting purpose. For example, the terms “forward,” “rearward,” “right,” “left,” “upper,” and “lower” designate directions in the drawings to which reference is made, with the terms “inward,” “interior,” “inner,” or “inboard” and “outward,” “exterior,” “outer,” or “outboard” referring, respectively, to directions toward and away from the center of the referenced element, and the terms “radial” or “horizontal” and “axial” or “vertical” referring, respectively, to directions, axes, planes perpendicular and parallel to the central longitudinal axis of the referenced element. Terminology of similar import other than the words specifically mentioned above likewise is to be considered as being used for purposes of convenience rather than in any limiting sense.

In the figures, elements having an alphanumeric designation may be referenced herein collectively or in the alternative, as will be apparent from context, by the numeric portion of the designation only. Further, the constituent parts of various elements in the figures may be designated with separate reference numerals which shall be understood to refer to that constituent part of the element and not the element as a whole. General references, along with references to spaces, surfaces, dimensions, and extents, may be designated with arrows.

For the illustrative purposes of the discourse to follow, the precepts of the tubular polymeric member of the invention herein involved are described in connection with its utilization as flexible tubing, which may be straight or coiled, such as for vehicular airbrake applications. Particular mono- or multi-layer constructions may be determined by balancing raw material costs with finished product performance and physical characteristics such flexibility, low temperature impact, high temperature burst strength, dimensional stability, and the like.

It will be appreciated, however, that aspects of the present invention may find use in other tubing applications, such as in multiple tube bundles or as a core tube or other member within a flexible pressure or vacuum hose construction such as for hydraulic or pneumatic power, signaling, control, or general fluid transfer applications. Use within those such other applications therefore should be considered to be expressly within the scope of the present invention.

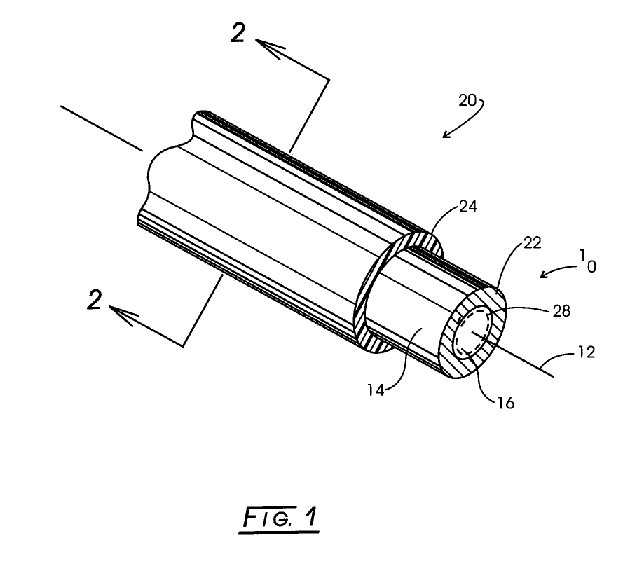

Referring then to the figures wherein corresponding reference characters are used to designate corresponding elements throughout the several views with equivalent elements being referenced with prime or sequential alphanumeric designations, a representative tubular polymeric member in accordance with the present invention is referenced at 10 in the perspective cut-away view of FIG. 1 as incorporated as a layer in a length of the multi-layer tubing construction referenced generally at 20. In such tubing construction 20, member 10, which may be straight as shown or coiled, extends lengthwise along a central longitudinal axis, 12. In the embodiment shown, member 10 has a circumferential outer surface, 14, and a circumferential inner surface, 16.

Member 10 may be extruded or otherwise fabricated, such as by molding, of an alloy compounded as a blend of a first thermoplastic material which may be a higher polyamide such as a nylon like Nylon 11 or 12, and a second thermoplastic material different from the first material. The second material likewise may be a polyamide such as a lower polyamide like Nylon 6 or 4. As used herein, the term “thermoplastic material” may be used interchangeably with “melt processible material,” and is in contrast to non-melt processible materials such as thermosets or non-thermosetting materials which otherwise exhibit a melt viscosity that is sufficiently high so as to preclude flow and processing by conventional melt extrusion or molding operations, and therefore necessitating that the material be processed using sintering or solvent processing techniques. Such materials, which may be referred herein as “resins,” typically will have a melting point of between about 110-230° C., and a thermal decomposition temperature, which defines the upper processing limit of the resin, of between about 150-260° C. As also used herein, “melting point” may be a transition from a form-stable crystalline or glassy solid phase to a softened or otherwise viscous phase which may be generally characterized as exhibiting intermolecular chain rotation and, as between layers, chain diffusion and/or other intermingling. For amorphous or other thermoplastic resins not having a clearly defined melting peak, the term melting point is used interchangeably with glass transition or softening point.

The first and second thermoplastic materials each themselves may be co-polymers or blends of one or more homopolymers, one or more co-polymers, or one or more homopolymers and one or more co-polymers. For example, in the case of the second thermoplastic material, the lower nylon may be a Nylon 6/6, 6/66/12, 6/6/9, 6/12, 66/12, 4/10, 4/12, or the like.

Also, the alloy material itself may be may be unfilled or, alternatively, compounded with one or more fillers, modifiers, or other additives. Such additives, which may be in liquid, powder, particulate, flake, fiber, or other form, may include compatibilizers, plasticizers, impact modifiers, electrically-conductive fillers, microwave-attenuating fillers, thermally-conductive fillers, lubricants, wetting agents, stabilizers, antioxidants, pigments, dyes, colorants, colorings, or opacifying agents such as for coloring-coding of the tubing, luminescents, light reflectants, chain extending oils, tackifiers, blowing agents, foaming or anti-foaming agents, reinforcements such as glass, carbon, or textile fibers, and fire retardants, metal oxides and salts, intercalated graphite particles, borates, siloxanes, phosphates, glass, hollow or solid glass or elastomeric microspheres, silica, silicates, mica, and the like. Typically, such additives may be blended or otherwise admixed with the alloy, and/or with one or more of the constituents thereof, and may comprise between about 0.1% and 80% or more by total weight or volume of the formulation.

As to the polyamide of the first thermoplastic material, for airbrake tubing applications a higher nylon of the type commonly used in such applications, such as a plasticized or unplasticized nylon which may be Nylon 11 or 12 as providing chemical resistance. As used herein, “chemical resistance” should be understood to mean the ability to resist swelling, crazing, stress cracking, corrosion, or otherwise to withstand attack from gasoline, diesel fuel, and other engine fluids or hydrocarbons, as well as organic solvents such as methanol, and inorganic solvents such as water or brine. The specific Nylon 11 or 12 grade may be chosen for reasons of cost and/or for service temperature, chemical compatibility with the fluid being handled, fluid, solvent, moisture, or environmental resistance, flexural modulus, hardness, or other physical property, and typically will have a melting point of between about 175-235° C. and a thermal decomposition temperature of between about 195-280° C.

As to the polyamide for the second thermoplastic material, again for airbrake tubing applications, a lower amide of the type commonly used in such applications, such as a plasticized or unplasticized nylon which may be Nylon 6 or 4, or a blend or co-polymer thereof such as Nylon 6/6, 6/66/12, 6/6/9, 6/12, 66/12, 4/10, or 4/12, as being of a lower cost than the higher nylons.

In the case that the selected first and second thermoplastic materials are incompatible, a compatibilizer may be admixed in the formulation. For the applications herein involved, such compatibilizers may include maleic anhydride-grafted olefins, or functionalized ethylene copolymers. Impact modifiers and plasticizers such as modified or functionalized ethylene or EPDM polymers and copolymers also may be included in the formulation. The alloy of the present invention further may be formulated, exclusive of any fillers, modifiers, additives, or other component, as blended or otherwise admixed of, for example, between about 10-50% by weight of the first thermoplastic material, between about 50-90% by weight of the second thermoplastic material.

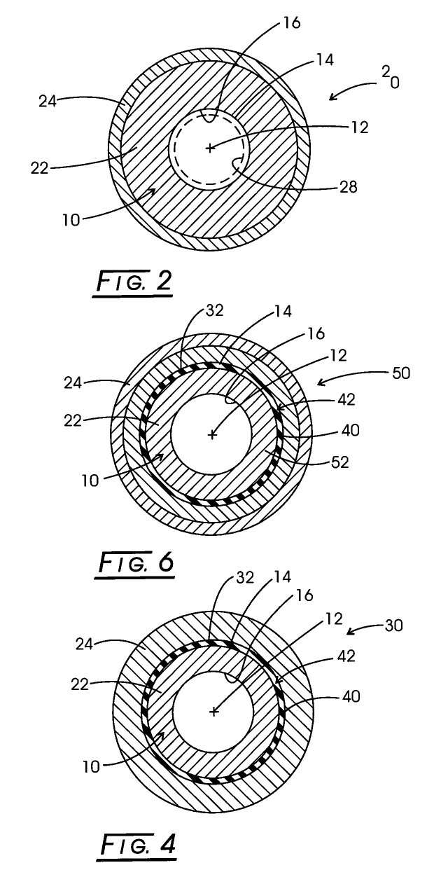

Looking additionally to the radial cross-section view of FIG. 2, the illustrated multi-layer tubing construction 20 incorporating member 10 is shown to be formed as an unreinforced 2-layer laminate of a tubular first layer, 22, formed by the member 10, and a tubular second layer, 24, which is concentric with the layer 22 and which itself may have an inner surface, 24, and an outer surface, 26. As shown, outer surface 26 of layer 24 may be the outermost layer of the construction 20. The layer 24 may be formed of a thermoplastic polymeric material which may be formulated as the same alloy as described in connection with the member 10. Alternatively, layer 24 may be formed of a general purpose resin such as a polyester, polyurethane, or polyurethane. For airbrake tubing applications, however, layer 24 may be a polyamide or blend, and particularly a polyamide of the type commonly used in such applications, such as a plasticized or unplasticized nylon which may be Nylon 6, 6/66, 6/12, or, for chemical resistance, a higher nylon such as Nylon 11 or 12. As before, the material forming the layer 24 may be filled or unfilled, and may be a homo or co-polymer, or a blend thereof, i.e., a blend of one or more homopolymers, one or more co-polymers, or one or more homopolymers and one or more co-polymers.

As shown in phantom at 28, in the tubing construction 20, as well as in any of the tubing constructions herein involved, an innermost layer of thermoplastic polymeric material, which again may be a polyamide polymer, co-polymer, or blend, and particularly a higher nylon such as Nylon 11 or 12, may be provided. In such constructions, the layer 26 may form the innermost layer of the construction 20 such as to provide increased chemical resistance.

With the layers 22 and 24 each being formed of a thermoplastic material, the tubing construction 20 may be formed by continuous co-extrusion or other extrusion such as cross-head or sequential extrusion. The outer layer 24 may be colored by blending the resin thereof with a color concentrate to provide a color throughout the thickness of the layer, or by utilizing a thin co-extruded color skin at the die, or by dip coating or spray adhesion.

Alternatively, the layers 22 and 24 may be molded or co-molded, or otherwise formed, such as via coating, or a combination of extrusion, molding, and/or coating. If formed of compatible materials, the layers 22 and 24 may be directly bonded together, such as by thermal fusion bonding, to form an integral, composite or laminate structure. Otherwise, if adjoining, the layers may be made into a composite via the use of an intermediate adhesive, tie, or other layer (not shown). Indeed, in other multi-layer construction, one or more additional layers, which may be the same as or different than the layers 22 and 24, may be provided in combination with those layers. Also, in any of the constructions, the layers may be reversed such that the outer surface 14 of the layer 22 may form the outermost surface of the construction 20.

Moreover, one or more reinforcement or additional resin layers, or a cover or jacket (not shown), may be knitted, braided, woven, wound, or wrapped in the case of a fiber, wire, metal foil, tape, film, or the like, or, alternatively, extruded, molded, or coated such as in the case of an additional resin layer resin layer, on or about, or otherwise as surrounding the construction 20 which, in such instance, may function as a core tube for such hose. The materials forming the reinforcement, cover, or additional resin layers may be loaded with metals, carbon black, pigments, dyes, reflectants or another fillers in particulate, flake, fiber, or other form so as to render the such construction electrically-conductive for applications requiring electrical conductivity or static dissipation, and/or, depending upon the filler, for providing color coding or increased visibility. Separate electrically-conductive or reflective fiber or resin layers, wires, and other elements (not shown) also may be incorporated within, in, or on the multi-layer structure of the construction 20 such as to provide electrical conductivity, static dissipation, or increased visibility.

The wall thicknesses of each of the layers 22 and 24 in the construction 20 may be of any thickness, both absolute and relative to the thickness of the other layer. For air brake tubing applications, however, the wall thickness of the layer 22 typically may be between about 35-75% and, typically, between about 45-60% of the overall wall thickness of the tubing construction 20, with the balance thereof being comprised of the layer 24.

Turning next to the several views of FIGS. 3 and 4, a representative 3-layer tubing construction incorporating member 10 of FIGS. 1 and 2 is referenced generally at 30. Such construction 30 is similar to that of the construction 20, with the exception that one or more reinforcement layers, 32, is interposed between the layers 22 and 24, and that the layer 24 is shown as being relatively thicker than in the construction 20. As to the reinforcement, each of the one or more reinforcement layers 32 may be, depending upon the required degree of flexibility and/or for ease of manufacture, braided, woven, wound, such as spiral or helically, loomed, axially-oriented, knitted, wrapped, or otherwise formed successively about, i.e., as surrounding, outer surface 14 of the inner layer 22, with the outer layer 24 then being extruded or otherwise formed over the reinforcement layer or layers 32. Each of the reinforcement layers 32 may be formed, of one or more filaments, which may be monofilaments, continuous multi-filament, i.e., yarn, stranded, cord, roving, thread, tape, or ply, or short “staple” strands, of one or more fiber materials. The fiber material, which may be the same or different in each of the layers 32 which are provided, may be a natural or synthetic polymeric material such as a nylon, cotton, polyester, polyamide, aramid, polyolefin, polyvinyl alcohol (PVA), polyvinyl acetate, or polyphenylene bezobisoxazole (PBO), or blend, a steel, which may be stainless or galvanized, brass, zinc or zinc-plated, or other metal wire, or a bi- or multi-component blend thereof.

For airbrake tubing applications, and as is shown in FIG. 3, a single reinforcement layer 32 typically will be provided as braided of a nylon, polyester, or aramid filament or yarn, and may have a relatively open structure with interstices, one of which is referenced at 40, between the filaments, referenced at 42, of the braid. The outer layer 24 thereby may be fusion or otherwise bonded directly to the reinforcing layer 32 or, alternatively, to the inner layer 22 through the interstices 40. The reinforcement layer 32 itself may be bonded to or between the layers 22 and 24 mechanically, such as by embedded in or encapsulated between the layers 22 and 24, or by other bonding means such as fusion, chemical, or adhesive bonding, or a combination thereof or otherwise. Such other bonding means may be effected by solvating, tackifying, or plasticizing the surfaces of the layers 22 and/or 24 with an appropriate solvent, such as a carboxylic or other organic acid, tackifier, or plasticizer such as an aqueous or other solution of an amine such as n-methyl pyrrolidone or a phenol such as meta-cresol or resorcinol, or with the use of a urethane, epoxy, vinyl chloride, vinyl acetate, methyl acrylic, or other adhesive having an affinity to the materials forming the layers 22 and 24, or otherwise in the manner described, for example, in U.S. Pat. Nos. 3,654,967; 3,682,201; 3,773,089; 3,790,419; 3,861,973; 3,881,975; 3,905,398; 3,914,146; 3,982,982; 3,988,188; 4,007,070; 4,064,913; 4,343,333; 4,898,212; and 6,807,988 and in the references cited therein, and in Japanese (Kokai) Publ. No. 10-169854 A2 and Canadian Pat. No. 973,074. The one or more reinforcement layers 32 also be an oriented extrusion or other layer of fillers including foam, liquid crystal polymer (LCP), nanoclay, or a compatibilized nylon/PET blend.

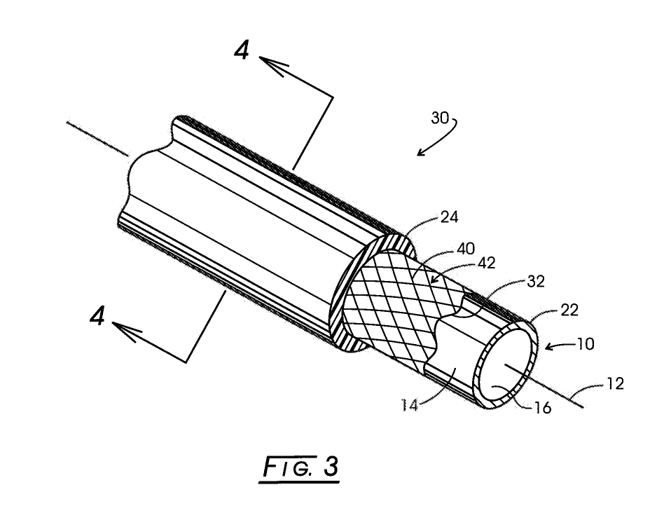

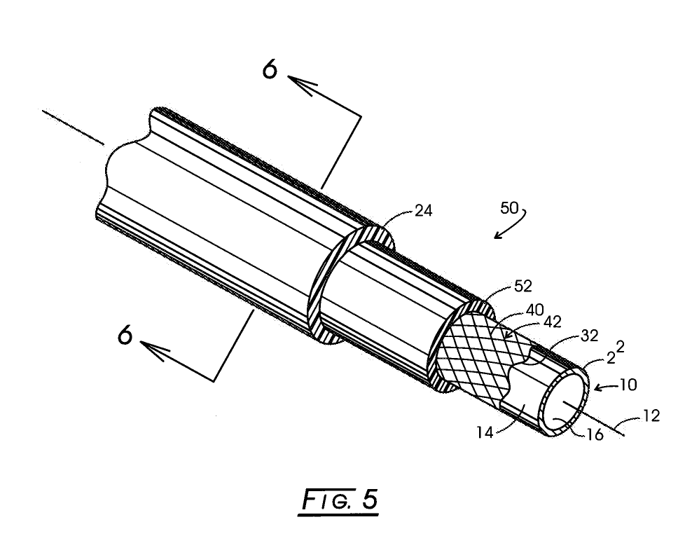

Looking lastly to the views of FIGS. 5 and 6, a representative 4-layer tubing construction generally at 50. Such construction 50 is similar to that of the construction 30, with the exception that and additional layer, 52, of the member 10 of FIGS. 1-3 is interposed between the layers 32 and 24, and that the layer 24 being shown as being relatively thinner than in the construction 30. In such construction 50, the combined wall thicknesses of the layers 22 and 52 again may be between about 35-75% and, typically, between about 45-60% of the overall wall thickness of the tubing construction 50, with the balance thereof being comprised of the layer 24.

As motioned, the Nylon 6/12 or other alloy of the first and second thermoplastic materials forming the member 10 may be made by blending, for example a Nylon 6 grade and a Nylon 12 grade, along with any other components such as compatibilizers, impact modifiers, plasticizer, or the like directly on-line in a continuous extrusion forming process. In such process, the constituents of the blend may be pre-mixed or mixed as the are being charged into the extruder, or as they are being heated and melted in the extruder, or in separate extruders, to form an economical Nylon 6/12 or other alloys. With the member 10 being so formed, reinforcement layers and other resin layers may be formed in multi-layer constructions in a conventional fashion. Alternatively, the alloy layer itself may be formed over other layers such as in certain of the constructions described herein in connection with the figures.

Thus, tubing incorporating the tubular polymeric member of the present invention and the construction thereof have been described.

As it is anticipated that certain changes may be made in the present invention without departing from the precepts herein involved, it is intended that all matter contained in the foregoing description shall be interpreted as illustrative and not in a limiting sense. All references including any priority documents cited herein are expressly incorporated by reference.

What is claimed is:

1. A tubular polymeric member formed of an alloy comprising a blend of:
a first thermoplastic material selected from the group consisting of Nylon 11, Nylon 12, and co-polymers and blends thereof; and
a second thermoplastic material different from the first material and selected from the group consisting of polyamides and co-polymers and blends thereof.

2. The tubular polymeric member of claim 1 wherein the second thermoplastic material is a lower nylon polymer or co-polymer.

3. The tubular polymeric member of claim 2 wherein the lower nylon polymer or co-polymer comprises Nylon 6 or Nylon 4.

4. The tubular polymeric member of claim 3 wherein the alloy comprises, based on the total weight of the first and the second thermoplastic material, between about 10-50% of the first thermoplastic material and between about 50-90% of the second thermoplastic material.

5. An article comprising a tubular polymeric member forming a tubular first layer within the article and being formed of an alloy comprising a blend of:
a first thermoplastic material selected from the group consisting of Nylon 11, Nylon 12, and co-polymers and blends thereof; and
a second thermoplastic material different from the first material and selected from the group consisting of polyamides and co-polymers and blends thereof.

6. The article of claim 5 wherein the second thermoplastic material is a lower nylon polymer or co-polymer.

7. The article of claim 6 wherein the lower nylon polymer or co-polymer comprises Nylon 6 or Nylon 4.

8. The article of claim 7 wherein the alloy comprises, based on the total weight of the first and the second thermoplastic material, between about 10-50% of the first thermoplastic material and between about 50-90% of the second thermoplastic material.

9. The article of claim 7 further comprising:
a tubular second layer concentric with the first layer, the second layer being bonded to the first layer and formed of a thermoplastic material the same as or different from the alloy forming the first layer.

10. The article of claim 9 wherein the thermoplastic material forming the second layer is selected from the group consisting of polyamides and co-polymers and blends thereof.

11. The article of claim 10 wherein the thermoplastic material forming the second layer is selected from the group consisting of Nylon 11, Nylon 12, and co-polymers and blends thereof.

12. The article of claim 11 wherein the article has an outermost surface formed by the second layer.

13. The article of claim 5 further comprising:
A tubular reinforcement layer concentric with the first layer, the reinforcement layer formed of one or more filaments of one or more fibers.

14. A method of extruding an article comprising a tubular polymeric member forming a tubular first layer within the article, the first layer being formed of a thermoplastic material, and the method comprising the steps in a continuous process of:
(a) blending a first thermoplastic material selected from the group consisting of Nylon 11, Nylon 12, and co-polymers and blends thereof, and a second thermoplastic material different from the first material and selected from the group consisting of polyamides and co-polymers and blends thereof to form an alloy;
(b) prior to or following step (a), melting the first and the second thermoplastic materials to form a melt of the alloy; and
(c) extruding the melt of the alloy to form the first layer of the article.

15. The method of claim 14 wherein the second thermoplastic material is a lower nylon polymer or co-polymer.

16. The method of claim 15 wherein the lower nylon polymer or co-polymer comprises Nylon 6 or Nylon 4.

17. The method of claim 16 wherein the alloy comprises, based on the total weight of the first and the second thermoplastic material, between about 10-50% of the first thermoplastic material and between about 50-90% of the second thermoplastic material.

18. The method of claim 16 wherein the article further comprises a tubular second layer concentric with and bonded to the first layer, the second layer being formed of a thermoplastic material the same as or different from the alloy, and the method further comprising the additional step prior to or following step (c) of extruding the thermoplastic material of the second layer to form the second layer of the article.

19. The method of claim 18 wherein the thermoplastic material forming the second layer is selected from the group consisting of polyamides and co-polymers and blends thereof.

20. The method of claim 19 wherein the thermoplastic material forming the second layer is selected from the group consisting of Nylon 11, Nylon 12, and co-polymers and blends thereof.

21. The method of claim 20 wherein the article has an outermost surface formed by the second layer.

22. The method of claim 14 wherein the article further comprises a tubular reinforcement layer concentric with the first layer, the reinforcement layer formed of one or more filaments of one or more fibers, and the method further comprising the additional step prior to or following step (c) of forming the reinforcement layer.
